(19) United States
(12) Patent Application Publication
(10) Pub. No.: US 2026/0032023 A1
(43) Pub. Date: Jan. 29, 2026

(54) DYNAMIC AC EQUALIZATION CIRCUIT

(71) Applicant: Apple Inc., Cupertino, CA (US)

(72) Inventors: Mitesh D. KATAKWAR, Santa Clara, CA (US); Craig B. BYINGTON, Pleasanton, CA (US); Yeshwanth Kumar MALLAVAJULA, Milpitas, CA (US)

(21) Appl. No.: 18/786,093

(22) Filed: Jul. 26, 2024

(51) Int. Cl. H04L 25/03; H04L 25/02

(52) U.S. Cl. CPC H04L 25/03878; H04L 25/0272

(57) ABSTRACT

An equalization circuit used in conjunction with a driver circuit for signal wires included in a communication bus is disclosed. The driver circuit may transmit a drive signal onto a signal wire based on a received data signal. The equalization circuit may transmit, based on the data signal and using a first current, a first equalization signal onto an equalization node that is coupled to the signal wire via a capacitor. The equalization circuit may also, in response to detecting a transition of the data signal, transmit a second equalization signal onto the equalization node using a second current greater than the first current.

### FIELD

The described embodiments relate generally to electronic circuits and, more particularly, to circuits used in high-speed communication links.

### BACKGROUND

Modern computer systems may include multiple circuit blocks designed to perform various functions. For example, such circuit blocks may include processors or processor cores configured to execute software or program instructions. Additionally, the circuit blocks may include memory circuits, mixed-signal circuits, analog circuits, and the like.

In some cases, multiple circuit blocks may be fabricated on a common integrated circuit. Alternatively, different circuit blocks may be fabricated on respective integrated circuits that are mounted on a common circuit board or substrate. Data may be transferred between the circuit blocks using high-speed communication links. For example, a processor circuit may send data to and receive data from one or more dynamic random-access memory (“DRAM”) circuits using one of various communication links such as a low-power double-data rate (LPDDR) link.

### BRIEF DESCRIPTION OF THE DRAWINGS

FIG. 1 is a block diagram depicting an embodiment of a driver subsystem for a communication bus.

FIG. 2 is a block diagram depicting a different embodiment of a driver subsystem that includes a t-coil circuit.

FIG. 3 is a block diagram depicting an embodiment of an equalization circuit.

FIG. 4 is a block diagram depicting an embodiment of an activation circuit for an equalization circuit.

FIG. 5 is a block diagram depicting an embodiment of a t-coil circuit.

FIG. 6 is a diagram depicting example waveforms associated with the operation of an activation circuit.

FIG. 7 is a block diagram depicting an embodiment of a system that includes two integrated circuits coupled together via a communication bus.

FIG. 8 is a flow diagram depicting an embodiment of a method for operating an equalization circuit for a driver subsystem.

FIG. 9 is a flow diagram depicting an embodiment of a method for training an equalization circuit for a driver subsystem.

FIG. 10 is a block diagram of an embodiment of a device that includes equalization circuits.

FIG. 11 is a block diagram of various embodiments of computer systems that may include equalization circuits.

FIG. 12 illustrates an example of a non-transitory computer-readable storage medium that stores circuit design information.

### DETAILED DESCRIPTION

Computer systems may include multiple integrated circuits configured to perform particular functions or operations. In some cases, one integrated circuit may exchange data with another integrated circuit via a communication bus, which may contain multiple wires or microstrip conductors.

To send data signals through a communication bus, integrated circuits may include multiple driver circuits designed to sink and source current from corresponding conductors in the communication bus to initiate voltage changes which can propagate along the conductors. In many cases, an impedance of a receiver circuit coupled to a communication bus conductor may not match the communication bus impedance which can cause a reflection of the transmitted signal. Such reflections can be further reflected when they propagate to the driver circuit, resulting in multiple reflections propagating through a communication bus conductor along with the data signals. The reflections can combine with the data signals reducing the amplitude of the data signals and limiting the bandwidth at which data can be transmitted on the communication bus.

To remediate such reflections, equalization drivers or circuits may be employed along with the driver circuits. Equalization circuits are often AC coupled to a communication bus using a capacitor and transmit equalization signals on the communication bus conductors based on the data signals. In many cases, the equalization signals are smaller in amplitude and out of phase with the transmitted data signals so that they can cancel some of the reflections.

In some cases, the capacitors used to AC couple equalization circuits to communication bus conductors can range from 100 fF to 1.5 pF. Such capacitors can load the communication bus conductors causing drops in the high levels of transmitted data. The drops in the high levels of the transmitted data can result in performance loss in transmitting data via the communication bus.

The embodiments illustrated in the drawings and described below may provide techniques for using a combination of strong and weak driver circuits in an equalization circuit to reduce the capacitor loading on a corresponding conductor in a communication bus. By using a weak driver that is on all the time with the data to be transmitted, along with a strong driver that is only active during transitions of the data to be transmitted, the effective loading of the AC coupling capacitor is reduced, thereby boosting performance of the communication bus.

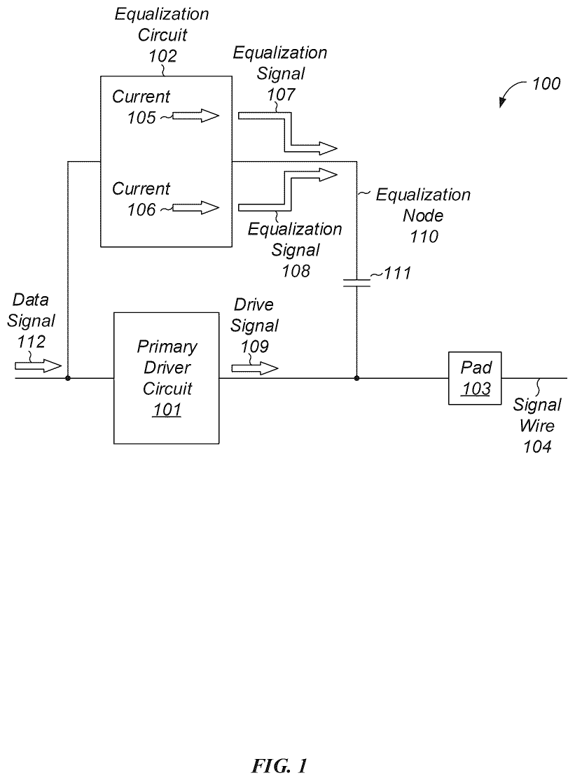

A block diagram of an embodiment of a driver subsystem is depicted in FIG. 1. As illustrated driver subsystem 100 includes primary driver circuit 101, equalization circuit 102, pad 103, signal wire 104, and capacitor 111.

Primary driver circuit 101 is coupled to pad 103 which is, in turn, coupled to signal wire 104. In various embodiments, signal wire 104 may be part of a communication bus coupled between multiple integrated circuits or devices, and may be implemented as a wire, microstrip conductor, or any other suitable type of conductor. Pad 103 may, in some embodiments, be implemented as a bond pad, a solder ball, or any other suitable structure configured to couple a driver or receiver circuit included on an integrated circuit to a wire, microstrip conductor, or any other suitable conductor.

Primary driver circuit 101 is configured, based on data signal 112, to transmit drive signal 109 onto signal wire 104. In various embodiments, primary driver circuit 101 may be configured to transmit drive signal 109 to signal 104 via pad 103.

Equalization circuit 102 is configured to transmit, using current 105, equalization signal 107 onto equalization node 110. In various embodiments, equalization node 110 is coupled to pad 103 via capacitor 111. In response to a detection of a transition of data signal 112, equalization circuit 102 is further configured to transmit, using current 106, equalization signal 108 onto equalization node 110. In various embodiments, current 106 is greater than current 105.

Capacitor 111 may, in various embodiments, be implemented as a metal-oxide-metal (MOM) capacitor structure, a metal-insulator-metal (MIM) structure, or any other suitable capacitor structure available on a semiconductor manufacturing process. In some embodiments, capacitor 111 may be implemented as a discrete capacitor separate from an integrated circuit that includes driver subsystem 100.

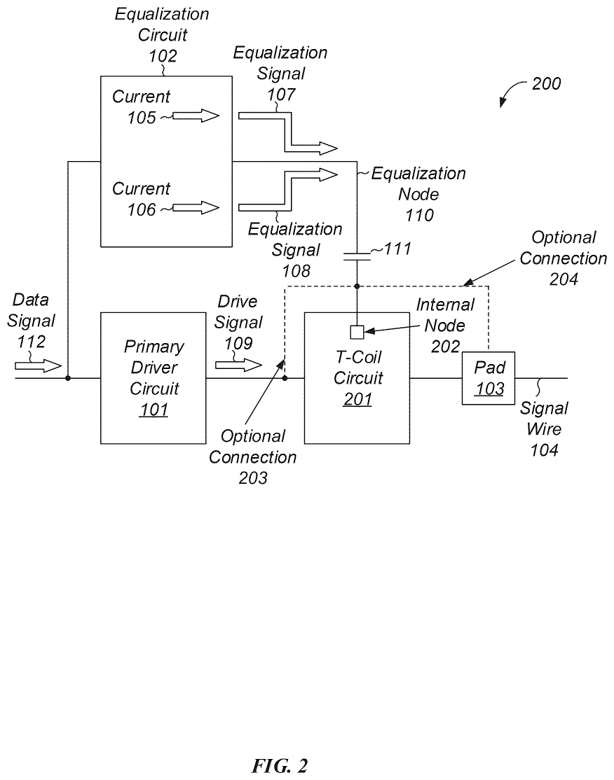

In some cases, a driver subsystem may employ a transmission coil (or “t-coil”) circuit to improve the impedance matching characteristics of the driver subsystem. An example of a driver subsystem that employs a t-coil circuit is depicted in FIG. 2. As illustrated, driver subsystem 200 includes primary driver circuit 101, equalization circuit 102, pad 103, capacitor 111, and t-coil circuit 201.

Primary driver circuit 101 is coupled to t-coil circuit 201 which is, in turn, coupled to pad 103. As described above, pad 103 is further coupled to signal wire 104, which may be part of a communication bus coupled between multiple integrated circuits or devices, and may be implemented as a wire, microstrip conductor, or any other suitable type of conductor. Pad 103 may, in some embodiments, be implemented as a bond pad, a solder ball, or any other suitable structure configured to couple a driver or receiver circuit included on an integrated circuit to a wire, microstrip conductor, or any other suitable conductor.

Primary driver circuit 101 is configured, based on data signal 112, to transmit drive signal 109 into t-coil circuit 201. In various embodiments, t-coil circuit 201 is further configured to relay drive signal 109 to pad 103.

Equalization circuit 102 is configured to transmit, using current 105, equalization signal 107 onto equalization node 110. In various embodiments, equalization node 110 is coupled to internal node 202 of t-coil circuit 201 via capacitor 111. In response to a detection of a transition of data signal 112, equalization circuit 102 is further configured to transmit, using current 106, equalization signal 108 onto equalization node 110. In various embodiments, current 106 is greater than current 105.

In some embodiments, equalization node 110 can be coupled to the output of primary driver circuit 101 via capacitor 111 and optional connection 203. In other cases, capacitor 111 may be split allowing equalization node 110 to be coupled to both internal node 202 as well as the output of primary driver circuit 101.

In other embodiments, equalization node 110 may be coupled to pad 103 via capacitor 111 and optional connection 204 instead of internal node 202. It is noted that such a connection between equalization node 110 and pad 103 may, in various embodiments, limit performance.

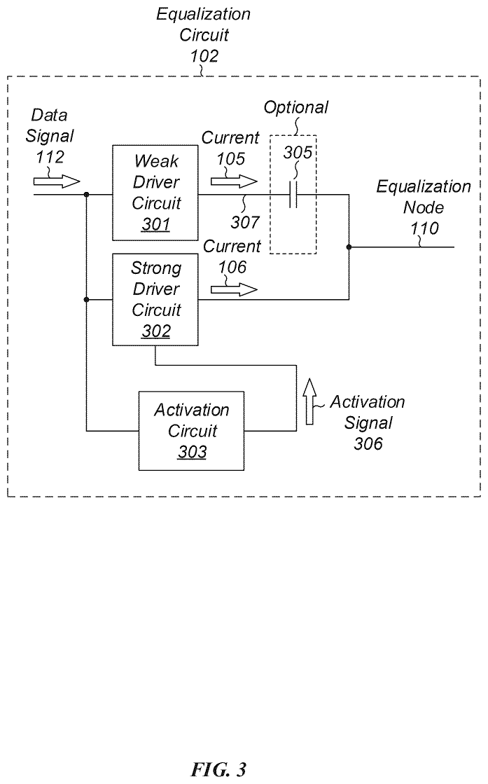

Turning to FIG. 3, a block diagram of an embodiment of equalization circuit 102 is depicted. As illustrated, equalization circuit 102 includes weak driver circuit 301, strong driver circuit 302, activation circuit 303, and optional capacitor 305.

Weak driver circuit 301 is configured, using data signal 112, to source current 105 to equalization node 110. In some embodiments, the output of weak driver circuit 301 is coupled to equalization node 110 via optional capacitor 305. In various embodiments, optional capacitor 305 may be implemented using a MOM capacitor structure, a MIM capacitor structure, or any other suitable capacitor structure available on a semiconductor manufacturing process. In cases where optional capacitor 305 is employed, as weak driver circuit 301 sources current 105 to node 307, the change in voltage of node 307 is coupled to equalization node 110 via capacitor 305.

Strong driver circuit 302 is configured, in response to a detection of a transition of data signal 112, to source current 106 to equalization node 110. In various embodiments, strong driver circuit 302 is configured to activate in response to a pulse on activation signal 306. Strong driver circuit 302 is further configured to deactivate in response to a determination that a duration of the activation pulse signal has elapsed.

As described above, current 106 generated by strong driver circuit 302 is greater than current 105 generated by weak driver circuit 301. The differences in the values of current 106 and current 105 can be realized using a variety of circuit techniques. Both strong driver circuit 302 and weak driver circuit 301 include devices coupled to equalization node 110 that are configured to source currents 106 and 105, respectively. To achieve the difference in the current values the transconductances of devices in strong driver circuit 302 are greater than the transconductances of devices in weak driver circuit 301, allowing the devices in strong driver circuit 302 to source more current to equalization node 110 than the devices in weak driver circuit 301.

In some embodiments, the devices in strong driver circuit 302 and weak driver circuit 301 may be implemented using metal-oxide semiconductor field-effect transistors (MOSFETs), Fin field-effect transistors (FinFETs), gate-all-around field-effect transistor (GAAFETs), or any other suitable transconductance devices. In such cases, the difference in the transconductances between the devices in strong driver circuit 302 and weak driver circuit 301 can be implemented by varying physical and/or electrical properties between the sets of devices. For example, transistors in strong driver circuit 302 may have widths greater than those of transistors in weak driver circuit 301. Alternatively, or additionally, channel lengths of transistors in weak driver circuit 301 may be greater than those of transistors in strong driver circuit 302. It is noted that other techniques, e.g., different bias conditions for the transistors in strong driver circuit 302 versus those for transistors in weak driver circuit 301, may also be employed in conjunction with the different physical properties.

Activation circuit 303 is configured to generate a pulse on activation signal 306 in response to a detection of a transition in data signal 112. As described below, the transition in data signal 112 may be a high-going transition or a low-going transition. In some embodiments, to generate the pulse on activation signal 306, activation circuit 303 may be further configured to combine data signal 112 and a delayed-version of data signal 112 using an exclusive-OR operation.

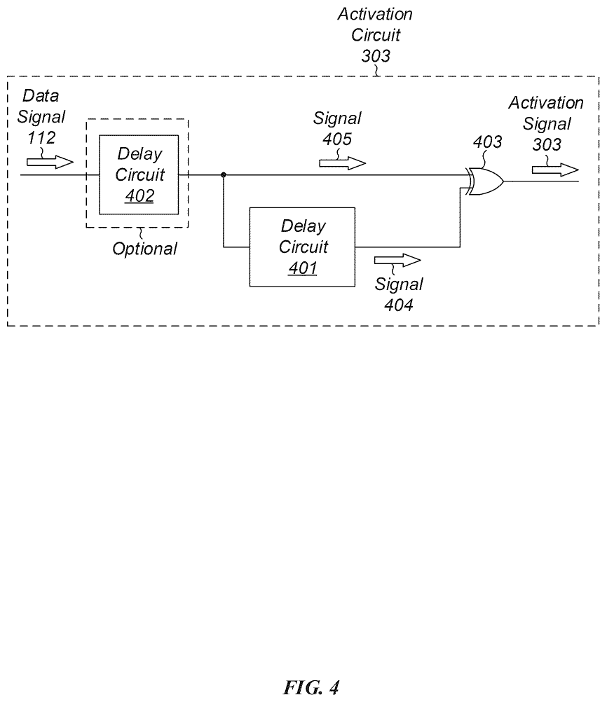

Turning to FIG. 4, a block diagram of an embodiment of activation circuit 303 is depicted. As illustrated, activation circuit 303 includes delay circuits 401-402 and exclusive-OR circuit 403. It is noted that delay circuit 402 is optional. In cases where delay circuit 402 is omitted, signal 405 is replaced by data signal 112.

Delay circuit 402 is configured to generate signal 405 using data signal 112. In various embodiments, signal 405 is a delayed version of data signal 112. In various embodiments, delay circuit 402 may be implemented using multiple logic gates coupled together in series. In some cases, respective capacitors may be coupled to the outputs of the multiple logic gates to increase the overall delay generated by delay circuit 402. In some embodiments, the overall delay generated by delay circuit 402 may be adjusted based on results of a training operation performed on a wire of a communication bus coupled to pad 103.

Delay circuit 401 is configured to generate signal 404 using signal 405 such that signal 404 is a delayed version of signal 405. In various embodiments, delay circuit 401 may be implemented using multiple logic gates coupled together in series. In some cases, respective capacitors may be coupled to the outputs of the multiple logic gates to increase the overall delay generated by delay circuit 401. In some embodiments, the overall delay generated by delay circuit 401 may be adjusted based on results of a training operation performed on a wire of a communication bus coupled to pad 103.

Exclusive-OR 403 circuit is configured to generate activation signal 306 using signal 405 and signal 404. In various embodiments, to generate activation signal 306, exclusive-OR circuit 403 is configured to perform the exclusive-OR logic operation using signal 404 and signal 405. In some cases, exclusive-OR circuit 403 may be implemented as a complex gate or any suitable combination of other logic gates, e.g., NAND gates, NOR gates, inverters, etc., arranged to implement the exclusive-OR logic operation.

It is noted that the embodiment depicted in FIG. 4 is merely an example. In other embodiments, different arrangements of delay circuits and logic gates may be employed to generate activation signal 306.

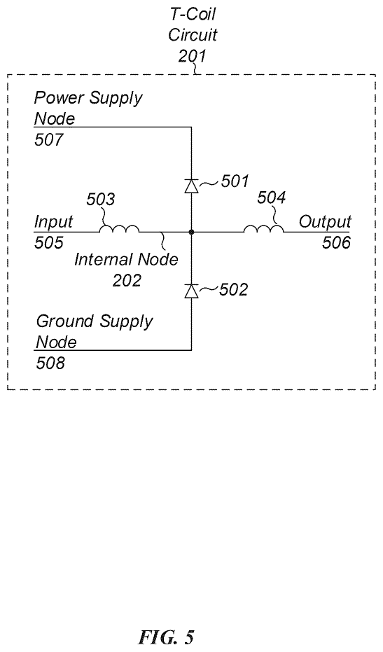

Turning to FIG. 5, a block diagram of an embodiment of t-coil circuit 201 is depicted. As illustrated, t-coil circuit 201 includes diodes 501-502 and inductors 503-504. As described above, t-coil circuit 201 may, in some embodiments, reduce reflections and improve the bandwidth of signal wire 104 coupled to pad 103.

Inductor 503 is coupled between input 505 and internal node 202, while inductor 504 is coupled between internal node 202 and output 506. In some cases, inductors 503 and 504 may be implemented as a single inductor with internal node 202 corresponding to a center tap of the single inductor. In various embodiments, inductors 503 and 504 may be implemented as coils of metal or other suitable conductive material fabricated on an integrated circuit that includes driver subsystem 200. In some cases, inductors 503 and 504 may be implemented as discrete inductors coupled to pad 103.

Diode 501 is coupled between power supply node 507 and internal node 202, while diode 502 is coupled between internal node 202 and ground supply node 508. In some cases, diodes 501 and 502 may be intrinsic devices located on an integrated circuit that includes driver subsystem 200. In other cases, diodes 501 and 502 may be discrete devices.

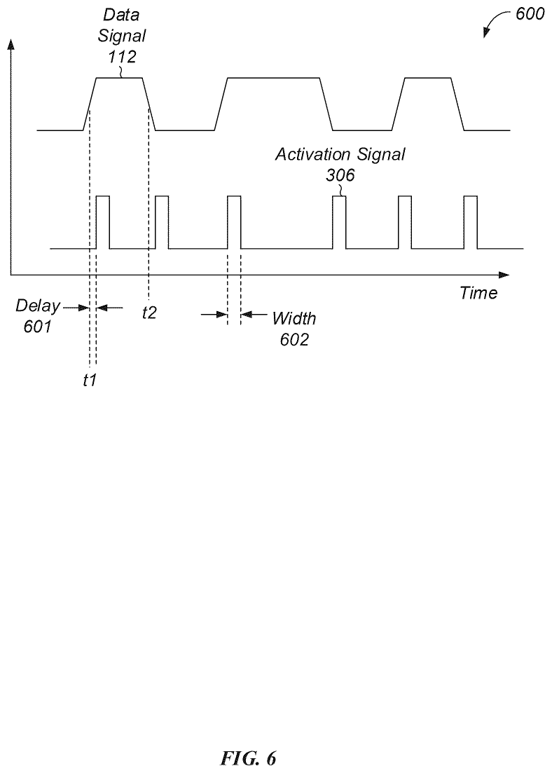

Turning to FIG. 6, example waveforms associated with the operation of activation circuit 303 are depicted. It is noted that the waveforms depicted in FIG. 6 are merely examples and that, in other embodiments, different timings between the various waveforms are possible and contemplated.

At time t1, data signal 112 transitions from a logical-0 value to a logical-1 value. After delay 601 has elapsed, activation signal 306 is activated, i.e., activation signal 306 transitions from a logical-0 value to a logical-1. As described above, the value of delay 601 can be adjusted based on the electrical characteristics of signal wire 104.

During the time that activation signal 306 is active, strong driver circuit 302 is activated, and current 106 is sourced to signal wire 104. In cases where optional t-coil circuit 201 is employed, current 106 is sourced to internal node 202 of optional t-coil circuit 201.

Activation signal 306 remains active for a time period corresponding to width 602. As described above, a delay circuit in activation circuit 303 may be adjusted to vary the value of width 602. In some cases, the value of width 602 may be adjusted based on data generated during a training operation as described below.

At time t2, data signal 112 transitions from a logical-1 value to a logical-0 value. In response to the low-going transition, activation signal 306 is again activated. In various embodiments, each high-going and low-going transition of data signal 112 generates a corresponding pulse on activation signal 306.

A block diagram of a system that includes two integrated circuits coupled together via a communication bus is depicted. As illustrated, system 700 includes device 701 and device 702 coupled together via communication bus 705. In various embodiments, both device 701 and device 702 may be integrated circuits. Although communication bus 705 is depicted as including three signal wires, in other embodiments, communication bus 705 may include any suitable number of signal wires.

Device 701 includes driver subsystems 703 and test circuit 706. In various embodiments, each of driver subsystems 703 may correspond to driver subsystem 100 as depicted in FIG. 1 or driver subsystem 200 as depicted in FIG. 2. Although only three driver subsystems are depicted as being included in device 701, in other embodiments, device 701 may include any suitable number of driver subsystems. In some cases, a number of driver subsystems included in device 701 may correspond to a number of signal wires included in communication bus 705. It is noted that device 701 may include other circuit blocks, e.g., processor circuits, analog/mixed-signal circuits, and the like, which have been omitted for clarity.

Device 702 includes receiver circuits 704. In various embodiments, receiver circuits 704 may be configured to receive signals transmitted over corresponding signal wires of communication bus 705, and sample the received signals to reconstruct data transmitted by device 701. Although only three receiver circuits are depicted as being included in device 702, in other embodiments, device 702 may include any suitable number of receiver circuits. It is noted that device 702 may include other circuit blocks, e.g., processor circuits, analog/mixed-signal circuits, and the like, which have been omitted for clarity.

Test circuit 706 is configured, in response to an activation of a training mode, to measure a response of communication bus 705 to generate test results. To measure the response of communication bus 705, test circuit 706 may be further configured to transmit respective test signals via corresponding ones of driver subsystems 703 onto respective signal wires of communication bus 705. In various embodiments, test circuit 706 may be configured to measure a magnitude of a reflection of a given test signal on a given signal wire of communication bus 705. In some embodiments, test circuit 706 may be further configured to measure a duration from the transmission of the given test signal on the given signal wire of communication bus 705 to receiving a corresponding reflection on the given signal wire.

Test circuit 706 may be further configured to adjust at least one respective timing parameter associated with driver subsystems 703. In various embodiments, to adjust the at least one respective timing parameter, test circuit 706 may be configured to adjust a duration that a strong driver circuit, e.g., strong driver circuit 302, included in the equalization circuit is active following detecting a transition in a data signal. In other embodiments, to adjust the at least one respective timing parameter, test circuit 706 may be further configured to adjust a delay from a transition of a data signal to activating the strong driver circuit. In some embodiments, to adjust the at least one respective timing parameter, test circuit 706 may be further configured to change a value of at least one variable delay circuit, e.g., delay circuit 401.

In various embodiments, device 701 may be configured to activate the training mode in response to a determination that a particular time period has elapsed since a previous activation of the training model. Alternatively, or additionally, device 701 may be configured to activate the training mode in response to a detection of a power-up mode or a reset mode. Device 701 may be configured, in response to an activation of the training mode, to couple test circuit 706 to a power supply node and/or a clock signal.

Device 701 may be further configured to deactivate the training mode in response to receiving a completion signal from test circuit 706. In response to a deactivation of the training mode, device 701 may be further configured to decouple test circuit 706 from the power supply node and/or the clock signal.

To summarize, various embodiments of a driver subsystem for a signal wire in a communication bus are disclosed. Broadly speaking, the driver subsystem includes a driver circuit and an equalization circuit. The driver circuit may be configured, based on a data signal, to transmit a drive signal onto a signal wire. The equalization circuit may be configured to transmit, using a first current and the data signal, a first equalization signal onto an equalization node that is coupled to the signal wire via a first capacitor. The equalization circuit may be further configured, in response to a detection of a transition of the data signal, to transmit, using a second current greater than the first current, a second equalization signal onto the equalization node.

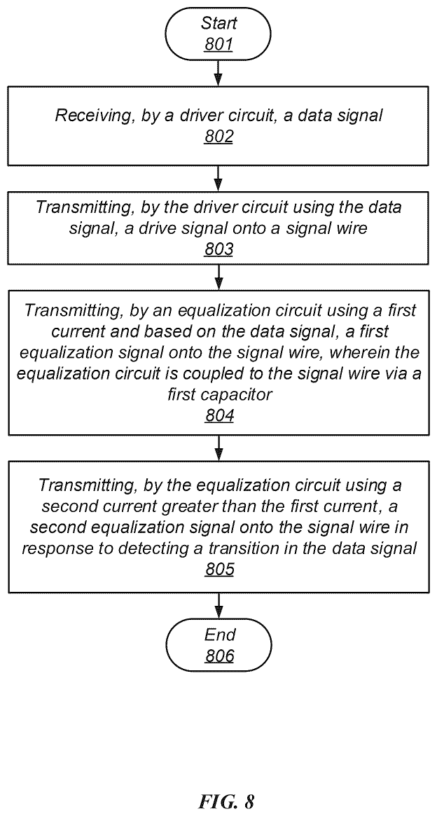

Turning to FIG. 8, a flow diagram depicting an embodiment of a method for operating an equalization circuit for a driver subsystem is illustrated. The method, which may be applied to various driver subsystems, e.g., driver subsystem 100 as depicted in FIG. 1 or driver subsystem 200 as depicted in FIG. 2, begins in block 801. The method includes receiving, by a driver circuit, e.g., primary driver circuit 101, a data signal (block 802).

The method further includes transmitting, by the driver circuit using the data signal, a drive signal onto a signal wire (block 803). In various embodiments, a first output node of the driver circuit is coupled to the signal wire via a t-coil circuit. In some embodiments, the t-coil circuit includes a first inductor and a second inductor coupled to an internal node.

The method also includes transmitting, by an equalization circuit using a first current and based on the data signal, a first equalization signal onto the signal wire (block 804). In various embodiments, the equalization circuit is coupled to the signal wire via a first capacitor. In cases where a t-coil circuit is coupled to the driver circuit, a second output of the equalization circuit is coupled to the internal node of the t-coil circuit.

In some embodiments, transmitting the first equalization signal includes sourcing, by a weak driver circuit included in the equalization circuit, the first current to a terminal of the first capacitor. In other embodiments, the weak driver circuit is coupled to the first capacitor via a second capacitor.

The method further includes transmitting, by the equalization circuit using a second current greater than the first current, a second equalization signal onto the signal wire in response to detecting a transition in the data signal (block 805). In various embodiments, the equalization circuit includes a strong driver circuit, and transmitting the second equalization signal includes driving, by the strong driver circuit using the second current, the first capacitor.

In other embodiments, transmitting the second equalization signal includes activating the strong driver circuit in response to detecting the transition in the data signal. In some embodiments, the method further includes generating a pulse signal in response to detecting the transition in the data signal, activating the strong driver circuit in response to activating the pulse signal, and deactivating the strong driver circuit in response to determining that a duration of the pulse signal has elapsed. The method concludes in block 806.

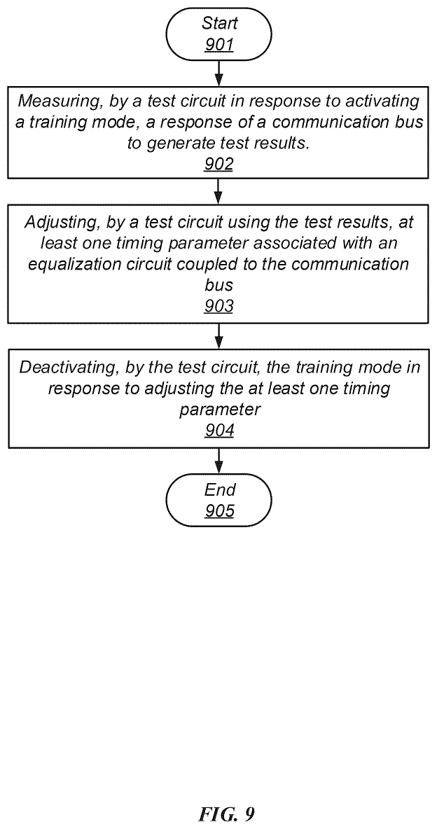

Turning to FIG. 9, a flow diagram depicting an embodiment of a method for training an equalization circuit for a driver subsystem is illustrated. The method, which may be applied to various driver subsystems, e.g., driver subsystem 100 as depicted in FIG. 1 or driver subsystem 200 as depicted in FIG. 2, begins in block 901.

The method includes measuring, by a test circuit in response to activating a training mode, a response of a communication bus to generate test results (block 902). In some embodiments, measuring the response of the communication bus includes transmitting a test signal on a least one signal wire included in the communication bus, where the test signal is based on test data. In such cases, the method may additionally include measuring a reflection of the test signal on the at least one signal wire. The method may further include measuring a duration from the transmission of the test signal to receiving the reflection of the test signal.

In various embodiments, the method may include activating the training mode in response to determining a particular time period has elapsed since a previous activation of the training mode. In other embodiments, the method may include activating the training mode in response to detecting a power-up mode or reset mode. In some embodiments, activating the test mode may include coupling the test circuit to a power supply node and a clock signal.

The method also includes adjusting, by a test circuit using the test results, at least one timing parameter associated with an equalization circuit coupled to the communication bus (block 903). In various embodiments, adjusting the at least one timing parameter includes adjusting a duration that a strong driver circuit included in the equalization circuit is active following detecting a transition in a data signal. In other embodiments, adjusting the at least one timing parameter may further include adjusting a delay from a transition of a data signal to activating the strong driver circuit. In some embodiments, adjusting the at least one timing parameter includes changing a value of at least one variable capacitor.

The method further includes deactivating, by the control circuit, the training mode in response to adjusting the at least one timing parameter (block 904). In various embodiments, deactivating the training mode includes switching the input of the driver subsystem from test data to live data to be transmitted. In some embodiments, deactivating the training mode further includes decoupling the test circuit from a power supply node and decoupling the test circuit from a clock signal. The method concludes in block 905.

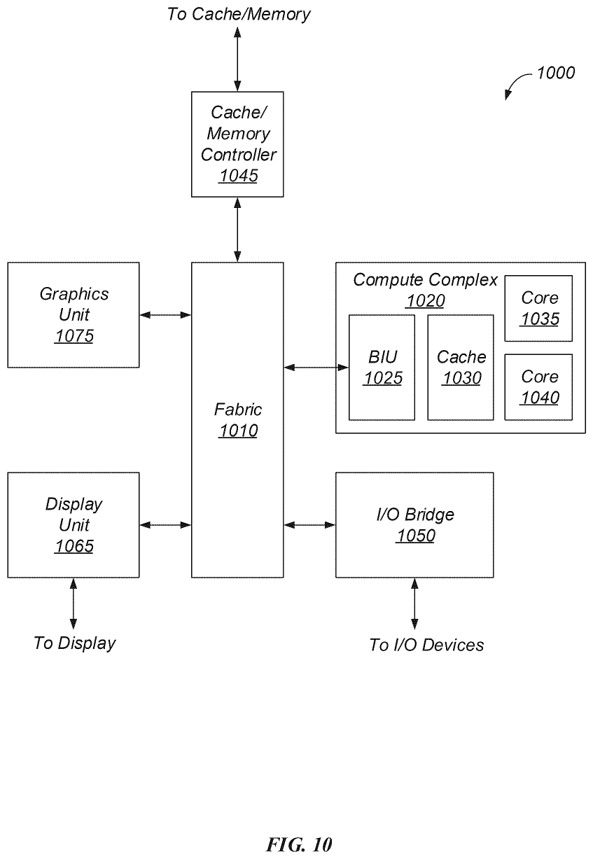

Referring now to FIG. 10, a block diagram illustrating an example embodiment of a device is shown. In various embodiments, device 1000 may implement functionality of driver subsystem 100 as depicted in FIG. 1, or driver subsystem 200 as depicted in FIG. 2. In some embodiments, elements of device 1000 may be included within a system on a chip. In some embodiments, device 1000 may be included in a mobile device, which may be battery-powered. Therefore, power consumption by device 1000 may be an important design consideration. In the illustrated embodiment, device 1000 includes fabric 1010, compute complex 1020, input/output (I/O) bridge 1050, cache/memory controller 1045, graphics unit 1075, and display unit 1065. In some embodiments, device 1000 may include other components (not shown) in addition to, or in place of, the illustrated components, such as video processor encoders and decoders, image processing or recognition elements, computer vision elements, etc.

Fabric 1010 may include various interconnects, buses, MUX's, controllers, etc., and may be configured to facilitate communication between various elements of device 1000. In some embodiments, portions of fabric 1010 may be configured to implement various different communication protocols. In other embodiments, fabric 1010 may implement a single communication protocol, and elements coupled to fabric 1010 may convert from the single communication protocol to other communication protocols internally.

In the illustrated embodiment, compute complex 1020 includes bus interface unit (BIU) 1025, cache 1030, and cores 1035 and 1040. In various embodiments, compute complex 1020 may include various numbers of processors, processor cores, and caches. For example, compute complex 1020 may include 1, 2, or 4 processor cores, or any other suitable number. In one embodiment, cache 1030 is a set associative L2 cache. In some embodiments, cores 1035 and 1040 may include internal instruction and data caches. In some embodiments, a coherency unit (not shown) in fabric 1010, cache 1030, or elsewhere in device 1000, may be configured to maintain coherency between various caches of device 1000. BIU 1025 may be configured to manage communication between compute complex 1020 and other elements of device 1000. Processor cores, such as cores 1035 and 1040, may be configured to execute instructions of a particular instruction set architecture (ISA) which may include operating system instructions and user application instructions. These instructions may be stored in a computer readable medium such as a memory coupled to cache/memory controller 1045 as discussed below.

As used herein, the term “coupled to” may indicate one or more connections between elements, and a coupling may include intervening elements. For example, in FIG. 10, graphics unit 1075 may be described as “coupled to” a memory through fabric 1010 and cache/memory controller 1045. In contrast, in the illustrated embodiment of FIG. 10, graphics unit 1075 is “directly coupled” to fabric 1010 because there are no intervening elements.

Cache/memory controller 1045 may be configured to manage transfer of data between fabric 1010 and one or more caches and memories. For example, cache/memory controller 1045 may be coupled to an L3 cache, which may, in turn, be coupled to a system memory. In other embodiments, cache/memory controller 1045 may be directly coupled to a memory. In some embodiments, cache/memory controller 1045 may include one or more internal caches. Memory coupled to cache/memory controller 1045 may be any type of volatile memory, such as dynamic random access memory (DRAM), synchronous DRAM (SDRAM), double data rate (DDR, DDR2, DDR3, etc.) SDRAM (including mobile versions of SDRAMs such as mDDR3, etc., and/or low power versions of SDRAMs such as LPDDR4, etc.), RAMBUS DRAM (RDRAM), static RAM (SRAM), etc. One or more memory devices may be coupled onto a circuit board to form memory modules such as single inline memory modules (SIMMs), dual inline memory modules (DIMMs), etc. Alternatively, the devices may be mounted with an integrated circuit in a chip-on-chip configuration, a package-on-package configuration, or a multi-chip module configuration. Memory coupled to cache/memory controller 1045 may be any type of non-volatile memory such as NAND flash memory, NOR flash memory, nano RAM (NRAM), magneto-resistive RAM (MRAM), phase change RAM (PRAM), Racetrack memory, Memristor memory, etc. As noted above, this memory may store program instructions executable by compute complex 1020 to cause the computing device to perform functionality described herein.

Graphics unit 1075 may include one or more processors, e.g., one or more graphics processing units (GPUs). Graphics unit 1075 may receive graphics-oriented instructions, such as OPENGL®, Metal®, or DIRECT3D® instructions, for example. Graphics unit 1075 may execute specialized GPU instructions or perform other operations based on the received graphics-oriented instructions. Graphics unit 1075 may generally be configured to process large blocks of data in parallel, and may build images in a frame buffer for output to a display, which may be included in the device or may be a separate device. Graphics unit 1075 may include transform, lighting, triangle, and rendering engines in one or more graphics processing pipelines. Graphics unit 1075 may output pixel information for display images. Graphics unit 1075, in various embodiments, may include programmable shader circuitry which may include highly parallel execution cores configured to execute graphics programs, which may include pixel tasks, vertex tasks, and compute tasks (which may or may not be graphics-related).

Display unit 1065 may be configured to read data from a frame buffer and provide a stream of pixel values for display. Display unit 1065 may be configured as a display pipeline in some embodiments. Additionally, display unit 1065 may be configured to blend multiple frames to produce an output frame. Further, display unit 1065 may include one or more interfaces (e.g., MIPI® or embedded display port (eDP)) for coupling to a user display (e.g., a touchscreen or an external display).

I/O bridge 1050 may include various elements configured to implement universal serial bus (USB) communications, security, audio, and low-power always-on functionality, for example. I/O bridge 1050 may also include interfaces such as pulse-width modulation (PWM), general-purpose input/output (GPIO), serial peripheral interface (SPI), and inter-integrated circuit (I2C), for example. Various types of peripherals and devices may be coupled to device 1000 via I/O bridge 1050.

In some embodiments, device 1000 includes network interface circuitry (not explicitly shown), which may be connected to fabric 1010 or I/O bridge 1050. The network interface circuitry may be configured to communicate via various networks, which may be wired, wireless, or both. For example, the network interface circuitry may be configured to communicate via a wired local area network, a wireless local area network (e.g., via Wi-Fi™), or a wide area network (e.g., the Internet or a virtual private network). In some embodiments, the network interface circuitry is configured to communicate via one or more cellular networks that use one or more radio access technologies. In some embodiments, the network interface circuitry is configured to communicate using device-to-device communications (e.g., Bluetooth® or Wi-Fi™ Direct), etc. In various embodiments, the network interface circuitry may provide device 1000 with connectivity to various types of other devices and networks.

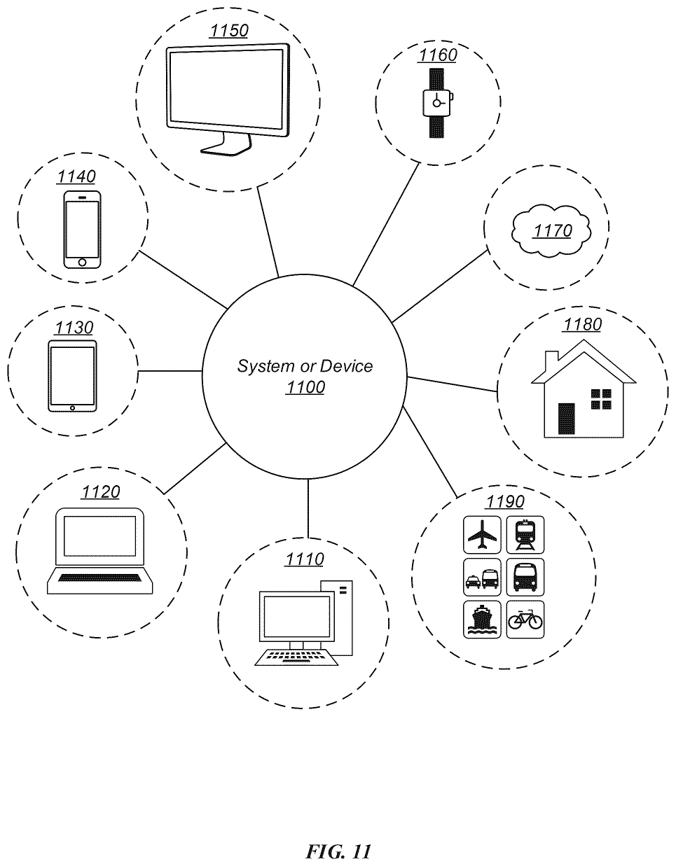

Turning now to FIG. 11, various types of systems that may include any of the circuits, devices, or systems discussed above are illustrated. System or device 1100, which may incorporate or otherwise utilize one or more of the techniques described herein, may be utilized in a wide range of areas. For example, system or device 1100 may be utilized as part of the hardware of systems such as a desktop computer 1110, laptop computer 1120, tablet computer 1130, cellular or mobile phone 1140, or television 1150 (or set-top box coupled to a television).

Similarly, disclosed elements may be utilized in a wearable device 1160, such as a smartwatch or a health-monitoring device. Smartwatches, in many embodiments, may implement a variety of different functions—for example, access to email, cellular service, calendar, health monitoring, etc. A wearable device may also be designed solely to perform health-monitoring functions, such as monitoring a user's vital signs, performing epidemiological functions such as contact tracing, providing communication to an emergency medical service, etc. Other types of devices are also contemplated, including devices worn on the neck, devices implantable in the human body, glasses or a helmet designed to provide computer-generated reality experiences such as those based on augmented and/or virtual reality, etc.

System or device 1100 may also be used in various other contexts. For example, system or device 1100 may be utilized in the context of a server computer system, such as a dedicated server or on shared hardware that implements a cloud-based service 1170. Still further, system or device 1100 may be implemented in a wide range of specialized everyday devices, including devices 1180 commonly found in the home such as refrigerators, thermostats, security cameras, etc. The interconnection of such devices is often referred to as the “Internet of Things” (IoT). Elements may also be implemented in various modes of transportation. For example, system or device 1100 could be employed in the control systems, guidance systems, entertainment systems, etc. of various types of vehicles 1190.

The applications illustrated in FIG. 11 are merely exemplary and are not intended to limit the potential future applications of disclosed systems or devices. Other example applications include, without limitation: portable gaming devices, music players, data storage devices, unmanned aerial vehicles, etc.

The present disclosure has described various example circuits in detail above. It is intended that the present disclosure cover not only embodiments that include such circuitry, but also a computer-readable storage medium that includes design information that specifies such circuitry. Accordingly, the present disclosure is intended to support claims that cover not only an apparatus that includes the disclosed circuitry, but also a storage medium that specifies the circuitry in a format that programs a computing system to generate a simulation model of the hardware circuit, programs a fabrication system configured to produce hardware (e.g., an integrated circuit) that includes the disclosed circuitry, etc. Claims to such a storage medium are intended to cover, for example, an entity that produces a circuit design, but does not itself perform complete operations such as design simulation, design synthesis, circuit fabrication, etc.

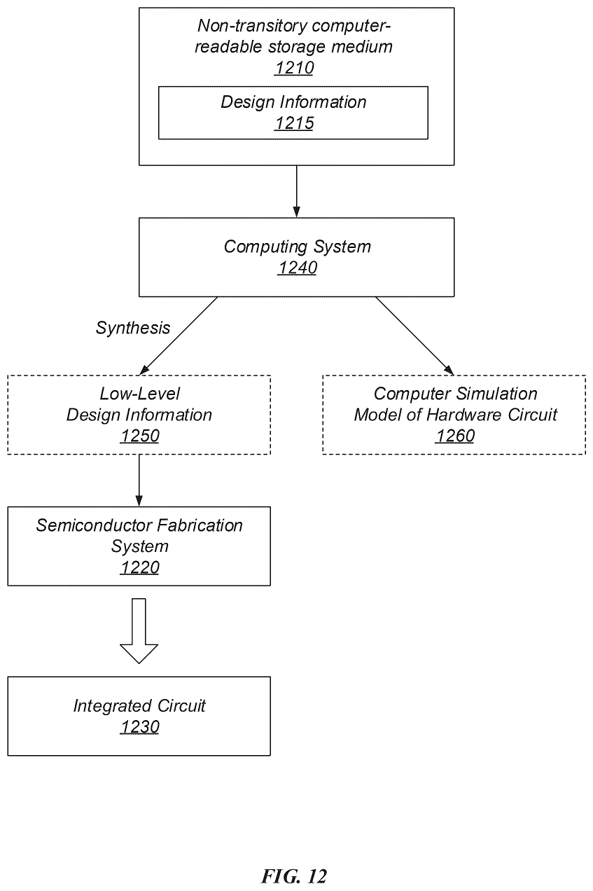

FIG. 12 is a block diagram illustrating an example of a non-transitory computer-readable storage medium that stores design information 1215, according to some embodiments. In the illustrated embodiment, computing system 1240 is configured to process design information 1215. This may include executing instructions included in design information 1215, interpreting instructions included in design information 1215, compiling, transforming, or otherwise updating design information 1215, etc. Therefore, design information 1215 controls computing system 1240 (e.g., by programming computing system 1240) to perform various operations discussed below, in some embodiments.

In the illustrated example, computing system 1240 processes design information 1215 to generate both computer simulation model of hardware circuit 1260 and low-level design information 1250. In other embodiments, computing system 1240 may generate only one of these outputs, may generate other outputs based on design information 1215, or both. Regarding computer simulation model of hardware circuit 1260, computing system 1240 may execute instructions of a hardware description language that includes register transfer level (RTL) code, behavioral code, structural code, or some combination thereof. The simulation model may perform the functionality specified by design information 1215, facilitate verification of the functional correctness of the hardware design, generate power consumption estimates, generate timing estimates, etc.

In the illustrated example, computing system 1240 also processes design information 1215 to generate low-level design information 1250 (e.g., gate-level design information, a netlist, etc.). This may include synthesis operations, as shown, such as constructing a multi-level network, optimizing the network using technology-independent techniques, technology dependent techniques, or both, and outputting a network of gates (with potential constraints based on available gates in a technology library, sizing, delay, power, etc.). Based on low-level design information 1250 (potentially among other inputs), semiconductor fabrication system 1220 is configured to fabricate integrated circuit 1230 (which may correspond to functionality of the computer simulation model of hardware circuit 1260). Note that computing system 1240 may generate different simulation models based on design information at various levels of description, including low-level design information 1250, design information 1215, and so on. The data representing low-level design information 1250 and computer simulation model of hardware circuit 1260 may be stored on non-transitory computer-readable storage medium 1210, or on one or more other media.

In some embodiments, low-level design information 1250 controls (e.g., programs) semiconductor fabrication system 1220 to fabricate integrated circuit 1230. Thus, when processed by the fabrication system, the design information may program the fabrication system to fabricate a circuit that includes various circuitry disclosed herein.

Non-transitory computer-readable storage medium 1210 may comprise any of various appropriate types of memory devices or storage devices. Non-transitory computer-readable storage medium 1210 may be an installation medium, e.g., a CD-ROM, floppy disks, or tape device; a computer system memory or random access memory such as DRAM, DDR RAM, SRAM, EDO RAM, Rambus RAM, etc.; a non-volatile memory such as a Flash memory, magnetic media, e.g., a hard drive, or optical storage; registers, or other similar types of memory elements, etc. Non-transitory computer-readable storage medium 1210 may include other types of non-transitory memory as well, or combinations thereof. Accordingly, non-transitory computer-readable storage medium 1210 may include two or more memory media, which may reside in different locations—for example, in different computer systems that are connected over a network.

Design information 1215 may be specified using any of various appropriate computer languages, including hardware description languages such as, without limitation: VHDL, Verilog, SystemC, System Verilog, RHDL, M, MyHDL, etc. The format of various design information may be recognized by one or more applications executed by computing system 1240, semiconductor fabrication system 1220, or both. In some embodiments, design information 1215 may also include one or more cell libraries that specify the synthesis, layout, or both of integrated circuit 1230. In some embodiments, design information 1215 is specified in whole, or in part, in the form of a netlist that specifies cell library elements and their connectivity. Design information discussed herein, taken alone, may or may not include sufficient information for fabrication of a corresponding integrated circuit. For example, design information may specify the circuit elements to be fabricated but not their physical layout. In this case, design information may be combined with layout information to actually fabricate the specified circuitry.

Integrated circuit 1230 may, in various embodiments, include one or more custom macrocells, such as memories, analog or mixed-signal circuits, and the like. In such cases, design information 1215 may include information related to included macrocells. Such information may include, without limitation, schematics capture database, mask design data, behavioral models, and device or transistor level netlists. Mask design data may be formatted according to graphic data system (GDSII), or any other suitable format.

Semiconductor fabrication system 1220 may include any of various appropriate elements configured to fabricate integrated circuits. This may include, for example, elements for depositing semiconductor materials (e.g., on a wafer, which may include masking), removing materials, altering the shape of deposited materials, modifying materials (e.g., by doping materials or modifying dielectric constants using ultraviolet processing), etc. Semiconductor fabrication system 1220 may also be configured to perform various testing of fabricated circuits for correct operation.

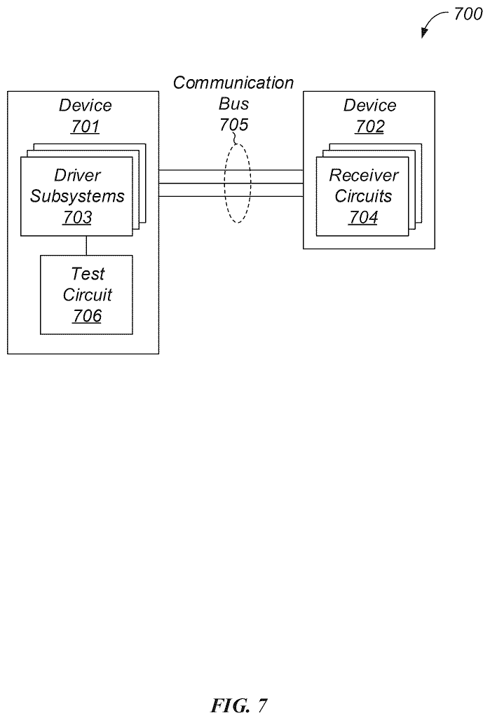

In various embodiments, integrated circuit 1230 and computer simulation model of hardware circuit 1260 are configured to operate according to a circuit design specified by design information 1215, which may include performing any of the functionality described herein. For example, integrated circuit 1230 may include any of various elements shown in FIGS. 1-5, and 7. Further, integrated circuit 1230 may be configured to perform various functions described herein in conjunction with other components. Further, the functionality described herein may be performed by multiple connected integrated circuits.

As used herein, a phrase of the form “design information that specifies a design of a circuit configured to . . . ” does not imply that the circuit in question must be fabricated in order for the element to be met. Rather, this phrase indicates that the design information describes a circuit that, upon being fabricated, will be configured to perform the indicated actions or will include the specified components. Similarly, stating “instructions of a hardware description programming language” that are “executable” to program a computing system to generate a computer simulation model does not imply that the instructions must be executed in order for the element to be met, but rather, specifies characteristics of the instructions. Additional features relating to the model (or the circuit represented by the model) may similarly relate to characteristics of the instructions, in this context. Therefore, an entity that sells a computer-readable medium with instructions that satisfy recited characteristics may provide an infringing product, even if another entity actually executes the instructions on the medium.

Note that a given design, at least in the digital logic context, may be implemented using a multitude of different gate arrangements, circuit technologies, etc. As one example, different designs may select or connect gates based on design tradeoffs (e.g., to focus on power consumption, performance, circuit area, etc.). Further, different manufacturers may have proprietary libraries, gate designs, physical gate implementations, etc. Different entities may also use different tools to process design information at various layers (e.g., from behavioral specifications to physical layout of gates).

Once a digital logic design is specified, however, those skilled in the art need not perform substantial experimentation or research to determine those implementations. Rather, those of skill in the art understand procedures to reliably and predictably produce one or more circuit implementations that provide the function described by design information 1215. The different circuit implementations may affect the performance, area, power consumption, etc. of a given design (potentially with tradeoffs between different design goals), but the logical function does not vary among the different circuit implementations of the same circuit design.

In some embodiments, the instructions included in design information 1215 provide RTL information (or other higher-level design information) and are executable by the computing system to synthesize a gate-level netlist that represents the hardware circuit based on the RTL information as an input. Similarly, the instructions may provide behavioral information and be executable by the computing system to synthesize a netlist or other lower-level design information included in low-level design information 1250. Low-level design information 1250 may program semiconductor fabrication system 1220 to fabricate integrated circuit 1230.

The present disclosure includes references to an “embodiment” or groups of “embodiments” (e.g., “some embodiments” or “various embodiments”). Embodiments are different implementations or instances of the disclosed concepts. References to “an embodiment,” “one embodiment,” “a particular embodiment,” and the like do not necessarily refer to the same embodiment. A large number of possible embodiments are contemplated, including those specifically disclosed, as well as modifications or alternatives that fall within the spirit or scope of the disclosure.

This disclosure may discuss potential advantages that may arise from the disclosed embodiments. Not all implementations of these embodiments will necessarily manifest any or all of the potential advantages. Whether an advantage is realized for a particular implementation depends on many factors, some of which are outside the scope of this disclosure. In fact, there are a number of reasons why an implementation that falls within the scope of the claims might not exhibit some or all of any disclosed advantages. For example, a particular implementation might include other circuitry outside the scope of the disclosure that, in conjunction with one of the disclosed embodiments, negates or diminishes one or more of the disclosed advantages. Furthermore, suboptimal design execution of a particular implementation (e.g., implementation techniques or tools) could also negate or diminish disclosed advantages. Even assuming a skilled implementation, realization of advantages may still depend upon other factors such as the environmental circumstances in which the implementation is deployed. For example, inputs supplied to a particular implementation may prevent one or more problems addressed in this disclosure from arising on a particular occasion, with the result that the benefit of its solution may not be realized. Given the existence of possible factors external to this disclosure, it is expressly intended that any potential advantages described herein are not to be construed as claim limitations that must be met to demonstrate infringement. Rather, identification of such potential advantages is intended to illustrate the type(s) of improvement available to designers having the benefit of this disclosure. That such advantages are described permissively (e.g., stating that a particular advantage “may arise”) is not intended to convey doubt about whether such advantages can in fact be realized, but rather to recognize the technical reality that realization of such advantages often depends on additional factors.

Unless stated otherwise, embodiments are non-limiting. That is, the disclosed embodiments are not intended to limit the scope of claims that are drafted based on this disclosure, even where only a single example is described with respect to a particular feature. The disclosed embodiments are intended to be illustrative rather than restrictive, absent any statements in the disclosure to the contrary. The application is thus intended to permit claims covering disclosed embodiments, as well as such alternatives, modifications, and equivalents that would be apparent to a person skilled in the art having the benefit of this disclosure.

For example, features in this application may be combined in any suitable manner. Accordingly, new claims may be formulated during prosecution of this application (or an application claiming priority thereto) to any such combination of features. In particular, with reference to the appended claims, features from dependent claims may be combined with those of other dependent claims where appropriate, including claims that depend from other independent claims. Similarly, features from respective independent claims may be combined where appropriate.

Accordingly, while the appended dependent claims may be drafted such that each depends on a single other claim, additional dependencies are also contemplated. Any combinations of features in the dependent claims that are consistent with this disclosure are contemplated and may be claimed in this or another application. In short, combinations are not limited to those specifically enumerated in the appended claims.

Where appropriate, it is also contemplated that claims drafted in one format or statutory type (e.g., apparatus) are intended to support corresponding claims of another format or statutory type (e.g., method).

Because this disclosure is a legal document, various terms and phrases may be subject to administrative and judicial interpretation. Public notice is hereby given that the following paragraphs, as well as definitions provided throughout the disclosure, are to be used in determining how to interpret claims that are drafted based on this disclosure.

References to a singular form of an item (i.e., a noun or noun phrase preceded by “a,” “an,” or “the”) are, unless context clearly dictates otherwise, intended to mean “one or more.” Reference to “an item” in a claim thus does not, without accompanying context, preclude additional instances of the item. A “plurality” of items refers to a set of two or more of the items.

The word “may” is used herein in a permissive sense (i.e., having the potential to, being able to) and not in a mandatory sense (i.e., must).

The terms “comprising” and “including,” and forms thereof, are open-ended and mean “including, but not limited to.”

When the term “or” is used in this disclosure with respect to a list of options, it will generally be understood to be used in the inclusive sense unless the context provides otherwise. Thus, a recitation of “x or y” is equivalent to “x or y, or both,” and thus covers 1) x but not y, 2) y but not x, and 3) both x and y. On the other hand, a phrase such as “either x or y, but not both” makes clear that “or” is being used in the exclusive sense.

A recitation of “w, x, y, or z, or any combination thereof” or “at least one of . . . w, x, y, and z” is intended to cover all possibilities involving a single element up to the total number of elements in the set. For example, given the set [w, x, y, z], these phrasings cover any single element of the set (e.g., w but not x, y, or z), any two elements (e.g., w and x, but not y or z), any three elements (e.g., w, x, and y, but not z), and all four elements. The phrase “at least one of . . . w, x, y, and z” thus refers to at least one element of the set [w, x, y, z], thereby covering all possible combinations in this list of elements. This phrase is not to be interpreted to require that there is at least one instance of w, at least one instance of x, at least one instance of y, and at least one instance of z.

Various “labels” may precede nouns or noun phrases in this disclosure. Unless context provides otherwise, different labels used for a feature (e.g., “first circuit,” “second circuit,” “particular circuit,” “given circuit,” etc.) refer to different instances of the feature. Additionally, the labels “first,” “second,” and “third,” when applied to a feature, do not imply any type of ordering (e.g., spatial, temporal, logical, etc.), unless stated otherwise.

The phrase “based on” is used to describe one or more factors that affect a determination. This term does not foreclose the possibility that additional factors may affect the determination. That is, a determination may be solely based on specified factors, or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

The phrases “in response to” and “responsive to” describe one or more factors that trigger an effect. This phrase does not foreclose the possibility that additional factors may affect or otherwise trigger the effect, either jointly with the specified factors or independent from the specified factors. That is, an effect may be solely in response to those factors, or may be in response to the specified factors as well as other, unspecified factors. Consider the phrase “perform A in response to B.” This phrase specifies that B is a factor that triggers the performance of A, or that triggers a particular result for A. This phrase does not foreclose that performing A may also be in response to some other factor, such as C. This phrase also does not foreclose that performing A may be jointly in response to B and C. This phrase is also intended to cover an embodiment in which A is performed solely in response to B. As used herein, the phrase “responsive to” is synonymous with the phrase “responsive at least in part to.” Similarly, the phrase “in response to” is synonymous with the phrase “at least in part in response to.”

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical). More specifically, this formulation is used to indicate that this structure is arranged to perform the one or more tasks during operation. A structure can be said to be “configured to” perform some task even if the structure is not currently being operated. Thus, an entity described or recited as being “configured to” perform some task refers to something physical, such as a device, a circuit, or a system having a processor unit and a memory storing program instructions executable to implement the task, etc. This phrase is not used herein to refer to something intangible.

In some cases, various units/circuits/components may be described herein as performing a set of tasks or operations. It is understood that those entities are “configured to” perform those tasks/operations, even if not specifically noted.

The term “configured to” is not intended to mean “configurable to.” An unprogrammed FPGA, for example, would not be considered to be “configured to” perform a particular function. This unprogrammed FPGA may be “configurable to” perform that function, however. After appropriate programming, the FPGA may then be said to be “configured to” perform the particular function.

For purposes of United States patent applications based on this disclosure, reciting in a claim that a structure is “configured to” perform one or more tasks is expressly intended not to invoke 35 U.S.C. § 112(f) for that claim element. Should Applicant wish to invoke Section 112(f) during prosecution of a United States patent application based on this disclosure, it will recite claim elements using the “means for” [performing a function] construct.

Different “circuits” may be described in this disclosure. These circuits or “circuitry” constitute hardware that includes various types of circuit elements, such as combinatorial logic, clocked storage devices (e.g., flip-flops, registers, latches, etc.), finite state machines, memory (e.g., random-access memory, embedded dynamic random-access memory), programmable logic arrays, and so on. Circuitry may be custom designed, or taken from standard libraries. In various implementations, circuitry can, as appropriate, include digital components, analog components, or a combination of both. Certain types of circuits may be commonly referred to as “units” (e.g., a decode unit, an arithmetic logic unit (ALU), a functional unit, a memory management unit (MMU), etc.). Such units also refer to circuits or circuitry.

The disclosed circuits/units/components and other elements illustrated in the drawings and described herein thus include hardware elements such as those described in the preceding paragraph. In many instances, the internal arrangement of hardware elements within a particular circuit may be specified by describing the function of that circuit. For example, a particular “decode unit” may be described as performing the function of “processing an opcode of an instruction and routing that instruction to one or more of a plurality of functional units,” which means that the decode unit is “configured to” perform this function. This specification of function is sufficient, to those skilled in the computer arts, to connote a set of possible structures for the circuit.

In various embodiments, as discussed in the preceding paragraph, circuits, units, and other elements may be defined by the functions or operations that they are configured to implement. The arrangement of such circuits/units/components with respect to each other and the manner in which they interact form a microarchitectural definition of the hardware that is ultimately manufactured in an integrated circuit or programmed into an FPGA to form a physical implementation of the microarchitectural definition. Thus, the microarchitectural definition is recognized by those of skill in the art as a structure from which many physical implementations may be derived, all of which fall into the broader structure described by the microarchitectural definition. That is, a skilled artisan presented with the microarchitectural definition supplied in accordance with this disclosure may, without undue experimentation and with the application of ordinary skill, implement the structure by coding the description of the circuits/units/components in a hardware description language (HDL) such as Verilog or VHDL. The HDL description is often expressed in a fashion that may appear to be functional. But to those of skill in the art in this field, this HDL description is the manner that is used to transform the structure of a circuit, unit, or component to the next level of implementational detail. Such an HDL description may take the form of behavioral code (which is typically not synthesizable), register transfer language (RTL) code (which, in contrast to behavioral code, is typically synthesizable), or structural code (e.g., a netlist specifying logic gates and their connectivity). The HDL description may subsequently be synthesized against a library of cells designed for a given integrated circuit fabrication technology, and may be modified for timing, power, and other reasons to result in a final design database that is transmitted to a foundry to generate masks and ultimately produce the integrated circuit. Some hardware circuits, or portions thereof, may also be custom-designed in a schematic editor and captured into the integrated circuit design along with synthesized circuitry. The integrated circuits may include transistors and other circuit elements (e.g., passive elements such as capacitors, resistors, inductors, etc.) and interconnect between the transistors and circuit elements. Some embodiments may implement multiple integrated circuits coupled together to implement the hardware circuits, and/or discrete elements may be used in some embodiments. Alternatively, the HDL design may be synthesized to a programmable logic array such as a field programmable gate array (FPGA) and may be implemented in the FPGA. This decoupling between the design of a group of circuits and the subsequent low-level implementation of these circuits commonly results in the scenario in which the circuit or logic designer never specifies a particular set of structures for the low-level implementation beyond a description of what the circuit is configured to do, as this process is performed at a different stage of the circuit implementation process.

The fact that many different low-level combinations of circuit elements may be used to implement the same specification of a circuit results in a large number of equivalent structures for that circuit. As noted, these low-level circuit implementations may vary according to changes in the fabrication technology, the foundry selected to manufacture the integrated circuit, the library of cells provided for a particular project, etc. In many cases, the choices made by different design tools or methodologies to produce these different implementations may be arbitrary.

Moreover, it is common for a single implementation of a particular functional specification of a circuit to include, for a given embodiment, a large number of devices (e.g., millions of transistors). Accordingly, the sheer volume of this information makes it impractical to provide a full recitation of the low-level structure used to implement a single embodiment, let alone the vast array of equivalent possible implementations. For this reason, the present disclosure describes structure of circuits using the functional shorthand commonly employed in the industry.

What is claimed is:

1. An apparatus, comprising:
a driver circuit configured, based on a data signal, to transmit a drive signal onto a signal wire; and
an equalization circuit configured to:
transmit, using a first current and the data signal, a first equalization signal onto an equalization node that is coupled to the signal wire via a first capacitor; and
in response to a detection of a transition of the data signal, transmit, using a second current greater than the first current, a second equalization signal onto the equalization node.

2. The apparatus of claim 1, wherein the equalization circuit includes a weak driver circuit configured, using the data signal, to source the first current to the equalization node.

3. The apparatus of claim 2, wherein an output of the weak driver circuit is coupled to the equalization node via a second capacitor.

4. The apparatus of claim 2, wherein the equalization circuit further includes a strong driver circuit configured, in response to the detection of the transition of the data signal, to source the second current to the equalization node.

5. The apparatus of claim 4, wherein the equalization circuit further includes an activation circuit configured to generate an activation pulse signal in response to the detection of the transition of the data signal, and wherein the strong driver circuit is further configured to:
activate in response to receiving the activation pulse signal; and
deactivate in response to a determination that a duration of the activation pulse signal has elapsed.

6. The apparatus of claim 1, wherein the driver circuit is coupled to the signal wire via a t-coil circuit that includes a first inductor and a second inductor coupled to an internal node, and wherein the first capacitor is coupled to the internal node of the t-coil circuit.

7. A method, comprising:
receiving, by a driver circuit, a data signal;
transmitting, by the driver circuit using the data signal, a drive signal onto a signal wire;
transmitting, by an equalization circuit using a first current and based on the data signal, a first equalization signal onto the signal wire, wherein the equalization circuit is coupled to the signal wire via a first capacitor; and
transmitting, by the equalization circuit using a second current greater than the first current, a second equalization signal onto the signal wire in response to detecting a transition in the data signal.

8. The method of claim 7, wherein transmitting the first equalization signal includes sourcing, by a weak driver circuit included in the equalization circuit, the first current to a terminal of the first capacitor.

9. The method of claim 8, wherein the weak driver circuit is coupled to the first capacitor via a second capacitor.

10. The method of claim 8, wherein the equalization circuit includes a strong driver circuit, and wherein transmitting the second equalization signal includes driving, by the strong driver circuit using the second current, the first capacitor.

11. The method of claim 10, wherein transmitting the second equalization signal includes activating the strong driver circuit in response to detecting the transition in the data signal.

12. The method of claim 11, further comprising:
generating a pulse signal in response to detecting the transition in the data signal;
activating the strong driver circuit in response to activating the pulse signal; and
deactivating the strong driver circuit in response to determining that a duration of the pulse signal has elapsed.

13. The method of claim 7, wherein a first output node of the driver circuit is coupled to the signal wire via a t-coil circuit that includes a first inductor and a second inductor coupled to an internal node, and wherein a second output node of the equalization circuit is coupled to the internal node.

14. A system, comprising:
a first device that includes a plurality of drive subsystems coupled to corresponding wires of a plurality of wires included in a communication bus, wherein the plurality of drive subsystems includes a particular drive subsystem that includes:
a driver circuit configured, based on a data signal, to transmit a drive signal onto a particular wire of the plurality of wires; and
an equalization circuit coupled to the particular wire via a first capacitor, wherein the equalization circuit is configured to:
drive the first capacitor using a first current and the data signal; and
in response to a detection of a transition of the data signal, drive the first capacitor using a second current greater than the first current.

15. The system of claim 14, wherein the equalization circuit includes a weak driver circuit configured to drive the first capacitor using the first current.

16. The system of claim 15, wherein an output of the weak driver circuit is coupled to the first capacitor via a second capacitor.

17. The system of claim 14, wherein the equalization circuit further includes a strong driver circuit, and wherein to drive the first capacitor using the second current, the equalization circuit is further configured to activate the strong driver circuit in response to the detection of the transition of the data signal.

18. The system of claim 17, wherein to activate the strong driver circuit, the equalization circuit is further configured to:
generate an activation pulse signal in response to the detection of the transition of the data signal;
activate the strong driver circuit using the activation pulse signal; and
deactivate the strong driver circuit in response to a determination that a duration of the activation pulse signal has elapsed.

19. The system of claim 18, wherein to generate the activation pulse signal, the equalization circuit is further configured to:
generate a delayed version of the data signal; and
combine the data signal and the delayed version of the data signal.

20. The system of claim 14, wherein the transition of the data signal includes a change in a voltage level of the data signal from a first value to a second value greater than the first value.
